(19) United States
(12) Patent Application Publication
(10) Pub. No.: US 2016/0246475 A1
(43) Pub. Date: Aug. 25, 2016

(54) DYNAMIC ICON RECOLORING TO IMPROVE CONTRAST

(71) Applicant: Microsoft Technology Licensing, LLC, Redmond, WA (US)

(72) Inventors: Hugo Garcia, Seattle, WA (US); Andrew Fomichev, Sammamish, WA (US)

(21) Appl. No.: 14/689,017

(22) Filed: Apr. 16, 2015

Related U.S. Application Data
(60) Provisional application No. 62/119,228, filed on Feb. 22, 2015.

(51) Int. Cl. G06F 3/0481; G06T 11/00; G06F 3/0482

(52) U.S. Cl. CPC G06F 3/04817; G06F 3/0482; G06T 11/001

(57) ABSTRACT

Technologies for dynamic recoloring of graphical elements on a user interface are described. In some examples, upon detecting a theme change that causes darker backgrounds on an application user interface, icons and/or other graphical elements on the user interface may be dynamically recolored based on a darkness (or lightness) of the new background, a location on the user interface, and a type of the icon or graphical element. Pixels of the icon or graphical element may be adjusted for hue, saturation, and/or luminance to increase the icon's contrast. In other examples, certain icons or graphical elements may be exempted from recoloring, for example, those with brand colors. In further examples, white or black glyphs may be created to represent the icons or graphical elements if contrast change by recoloring is determined to be insufficient for a satisfying user experience.

### CROSS-REFERENCE TO RELATED APPLICATIONS

This application claims benefit under 35 U.S.C. §119(e) of U.S. Provisional Patent Application Ser. No. 62/119,228 filed on Feb. 22, 2015. The disclosure of the U.S. Provisional Patent Application is hereby incorporated by reference in its entirety.

### BACKGROUND

Users interact with applications through user interfaces, where commands, configurations, options, and other information are typically presented through text and/or graphics. Graphical representations such as icons make it easier to interact because it is easier for users to remember icons. Furthermore, icons may be part of branding strategy distinguishing an application from others with similar functionality.

With increase computing power, graphics capabilities, and memory capacity, graphical aspects of user interfaces have become richer and more complex compared to original text based user interfaces, where color of text and color background may have been the only variables. In today's application environments, colors, styles, sizes, and many other attributes of text and graphics may be adjustable/selectable. In some cases, themes that include specific color, style, size, etc. settings may be selectable, which may allow users to configure multiple settings with one selection. However, when certain themes are selected, for example, those with dark background colors, there may be an undesired effect on user experience where icons or other graphical elements may not be as visible as before due to contrast degradation.

### SUMMARY

This summary is provided to introduce a selection of concepts in a simplified form that are further described below in the Detailed Description. This summary is not intended to exclusively identify key features of the claimed subject matter, nor is it intended as an aid in determining the scope of the claimed subject matter.

Examples are directed to dynamic recoloring of graphical user interface elements. According to an example method a background change in a portion of a displayed user interface may be detected; for each graphical element displayed on the portion of the user interface, one or more pixels may be selected to be adjusted; a graphical element may be recolored by adjusting one or more parameters of the selected one or more pixels to enhance a contrast of the graphical element against the changed background; and rendering of the recolored graphical element on the user interface may be enabled, where the one or more parameters are adjusted at individual graphical element level.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example application user interface with icons and other graphical elements, where dynamic recoloring may be implemented to enhance contrast;

FIGS. 2A and 2B illustrate example icons on a darker background before and after recoloring, which enhances their contrast with the background;

FIG. 2C illustrates another approach to enhance icon contrast over darker backgrounds by converting the icons into white glyphs;

FIGS. 3A and 3B illustrate another example of contrast enhancement of icons on a darker background before and after recoloring;

FIG. 4 illustrates an example user interface for manually adjusting color attributes of icons to enhance contrast;

FIG. 5 illustrates an example system, where dynamic recoloring to enhance contrast may be implemented;

FIG. 6 is a block diagram of an example general purpose computing device, which may be used to implement dynamic recoloring to enhance contrast; and

FIG. 7 illustrates a logic flow diagram of a method to provide dynamic recoloring to enhance contrast, according to at least some examples disclosed herein.

### DETAILED DESCRIPTION

As briefly described above, upon detecting a theme change that causes darker backgrounds on an application user interface, icons and/or other graphical elements on the user interface may be dynamically recolored based on a darkness (or lightness) of the new background, a location on the user interface, and a type of the icon (or graphical element). Pixels of the icon or graphical element may be adjusted for hue, saturation, and/or luminance to increase the icon's contrast. According to some examples, certain icons or graphical elements may be exempted from recoloring, for example, those with brand colors. According to other examples, white or black glyphs may be created to represent the icons or graphical elements if contrast change by recoloring is determined to be insufficient for a satisfying user experience.

In the following detailed description, references are made to the accompanying drawings that form a part hereof, and in which are shown by way of illustrations, specific examples, or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While some examples will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that examples may be practiced with other computer system configurations, including hand-held devices, multiprocessor systems, microprocessor-based or programmable consumer electronics, minicomputers, mainframe computers, and comparable computing devices. Examples may also be practiced in distributed computing environments where tasks are performed by remote processing devices that are linked through a communications network. In a distributed computing environment, program modules may be located in local and remote memory storage devices.

Some examples may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for dynamic icon recoloring to improve contrast. Examples of platforms include, but are not limited to, a hosted service executed over a plurality of servers, an application executed on a highest prioritized computing device, and comparable systems. The term “server” generally refers to a computing device executing one or more software programs typically in a networked environment. More detail on these technologies and example operations is provided below.

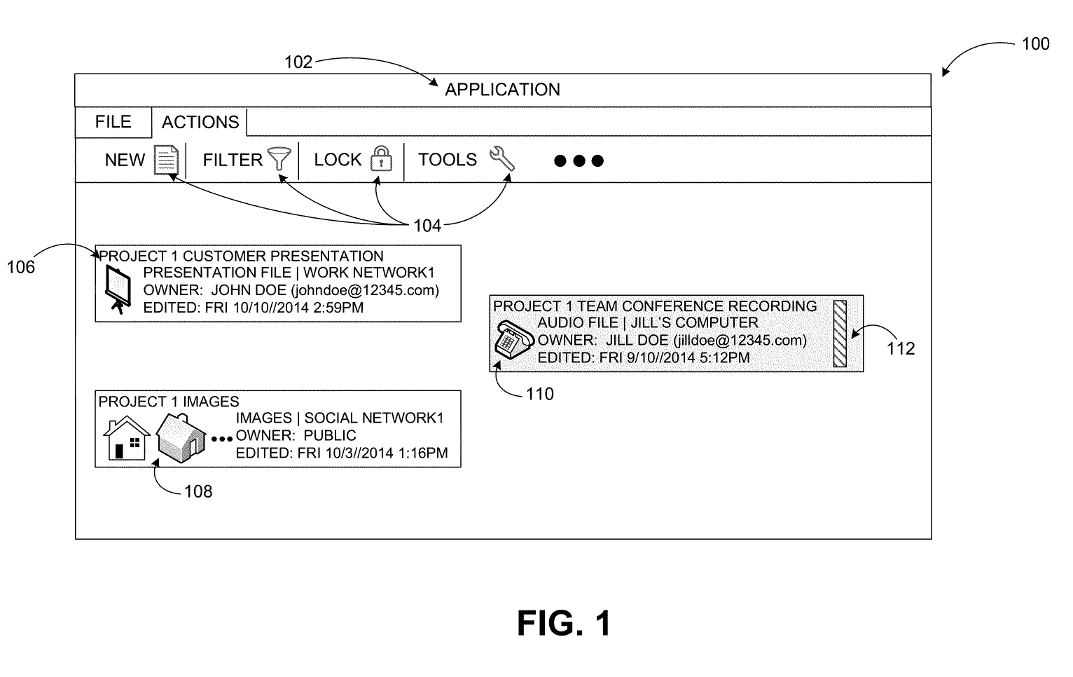

FIG. 1 illustrates an example application user interface with icons and other graphical elements, where dynamic recoloring may be implemented to enhance contrast, according to at least some examples disclosed herein.

A user interface 102 in a diagram 100 may be representative of an application user interface. Example applications may include, but are not limited to, word processing applications, spreadsheet applications, presentation applications, graphics applications, communication applications, browsers, and comparable ones. As shown on the user interface 102, icons 104 (typically colored) may be used with or without text to represent commands, options, configuration settings, and other application related information.

The example user interface may also include content elements, such as graphics 106, 108, 110, and 112, some of which may be images. In addition to the illustrated content elements, other graphics (or images) may be used at different locations on the user interface to present information or to enable users to interact in various ways. Depending on the type of theme used, different locations of the user interface 102 may change in background color or shade when a new theme is selected. For example, the command menu presenting the icons 104 may become darker than other portions of the user interface. Thus, the impact of the theme change may be different on the icons and graphical elements (including images) depending on the location of the icons and graphical elements on the user interface. Examples are not limited to dynamic recoloring of icons. According to some examples, graphical elements and/or images in the displayed content or other sections of the user interface may also be recolored based on the corresponding background change.

In some examples, a dynamic recoloring module may detect contrast change between an icon (or graphical element) and its background upon detecting a theme change. The dynamic recoloring module may then adjust select pixels of the icon or graphical element such that the contrast is increased and the icon or graphical element becomes more visible. In other examples, the dynamic recoloring module or another module may monitor/detect contrast changes in icons or other user interface elements and initiate the recoloring automatically. While recoloring may be performed automatically based on predefined parameters in some cases, users may be allowed to select or set certain recoloring parameters in other cases.

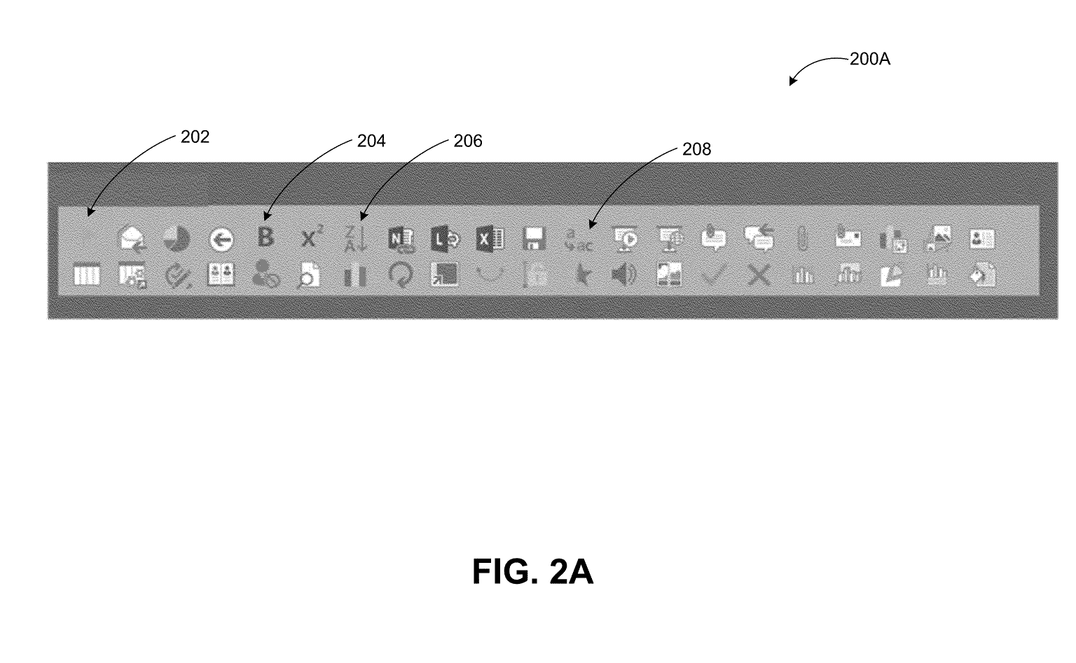

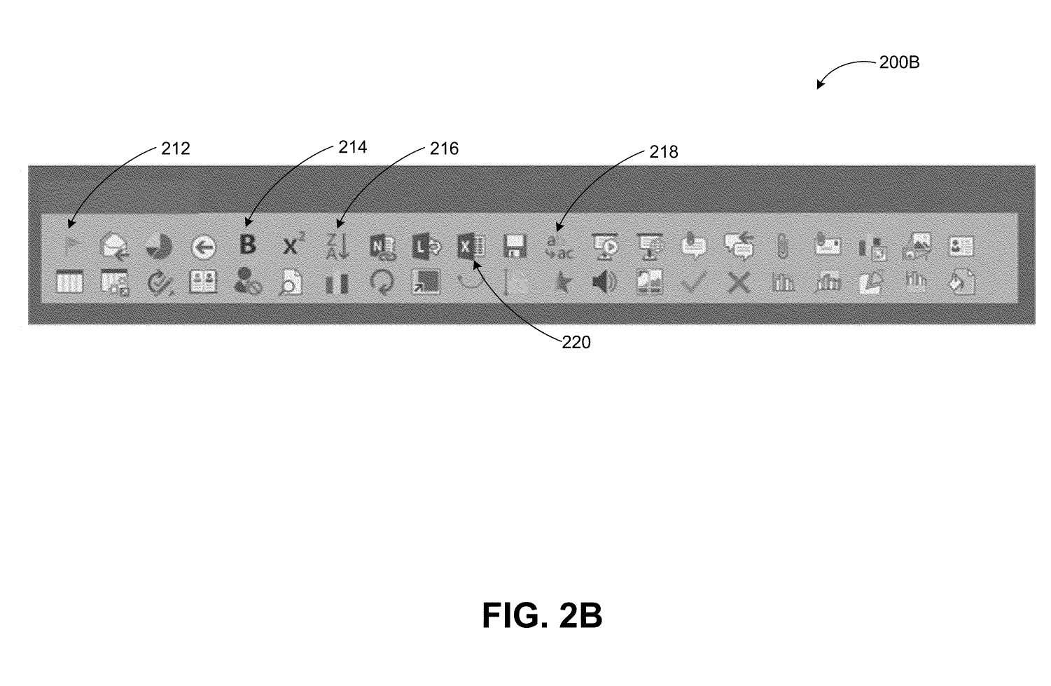

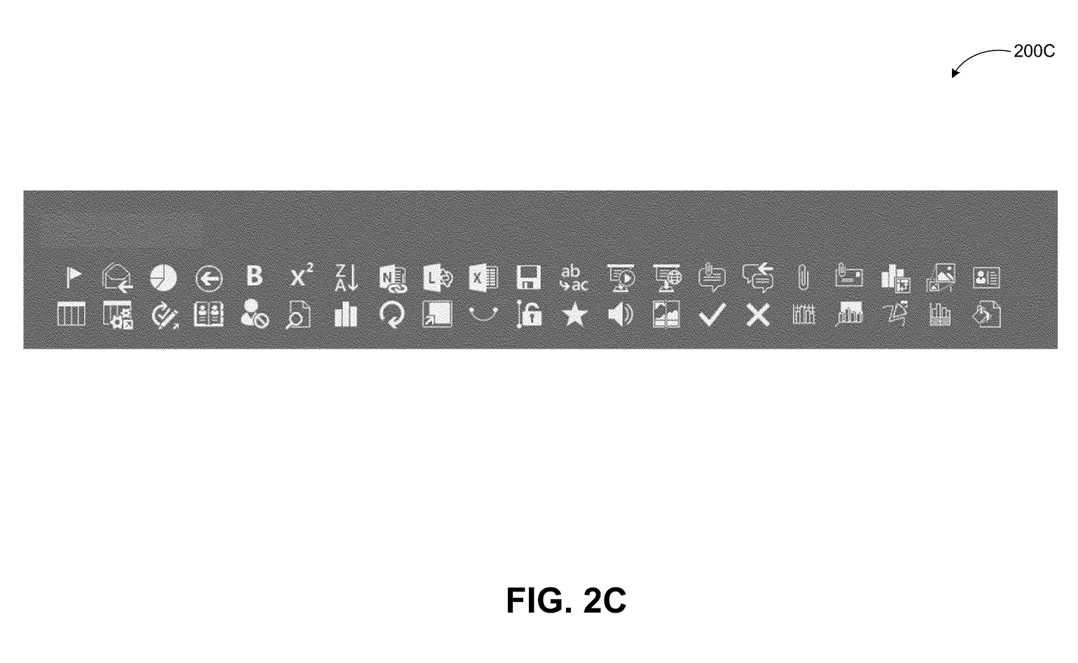

FIGS. 2A and 2B illustrate example icons on a darker background before and after recoloring, which enhances their contrast with the background, according to at least some examples disclosed herein.

A number of icons 200A are shown in FIG. 2A after a background of the number of icons 200A has been edited to a darker shade of gray. The change in a background color and/or a background shade may render some icons as less visible due to loss of contrast. For example, a flag icon 202 may be barely visible. Similarly, example icons 204, 206, and 208 may be less contrasted and may be more difficult to see. Depending on individual color composition, shape, size, and design, not all icons may be affected the same way. Some may retain their visibility despite the background change, others may be degraded more as in the example of flag icon 202. Thus, an approach changing colors or brightness of all icons at the same level may not achieve a desired improvement, and instead make some icons worse. A system according to examples may treat icons (or other graphical elements) individually at the pixel level ensuring visibility (contrast) improvements for those that need it while leaving those that do not need improvement in their original form.

Upon dynamic recoloring, the visibility of the icons may be improved as shown in example icons 200B. For example, a recolored flag icon 212 is now visible. Other icons, such as recolored example icons 214, 216, and 218, may also appear more contrasted and visible compared to the original versions.

According to examples, the icons may also be recolored at the pixel level. The icons may appear as rectangular bitmaps of pixels (for example, 16 by 16 or 32 by 32). Some of the pixels may be transparent or may appear similar to a color of the background. Thus, no change may be needed for those pixels. A dynamic recoloring module, according to examples, may select pixels that need a change to increase the contrast of the icon and adjust them. The icons may be rendered in a RGB (red, green, blue) color system. The dynamic recoloring module may convert the color system to an HSL (hue-saturation-luminance) system and adjust hue, saturation, and luminance parameters of selected pixels individually. While HSL system is used as an example color adjustment system herein, embodiments are not limited to HSL, and other color definition/adjustment systems may also be used. Furthermore, HSL's common definition of hue-saturation-luminance is used herein. A similar—and as valid—definition uses “lightness” instead of “luminance”, where lightness is a representation of variation in the perception of a color or color space's brightness.

To determine which pixels may need to be adjusted and by what percentage, a heuristic-based approach may be used. In yet other examples, predefined values may also be used. In further examples, the contrast change of the icons following the background change may be determined programmatically and the adjustments made accordingly. For example, yellow pixels may be darkened slightly more than red pixels since yellow is harder to read against a dark background. Similarly, different shades of gray may be adjusted independently to make the icons more visible against different backgrounds. In some examples, certain icons or graphic elements may represent branding themes such as example icon 220 representing Microsoft Excel® spreadsheet application. The green color is a brand color. Therefore, the dynamic recoloring module may not change the parameters for that icon to preserve the brand color(s).

FIG. 2C illustrates another approach to enhance icon contrast over darker backgrounds by converting the icons into white glyphs, according to at least some examples disclosed herein.

For certain dark shades of gray, adjustment of pixel parameters such as hue, saturation, and luminance, may not be sufficient and some icons may not be visible at a desired level. In such cases, all color may be removed and the icons stylized (glyph) in black and white colors. Example icons 200C in FIG. 2C illustrate the icons of FIG. 2A converted into white glyphs. Of course, the colors may be inverted (black glyphs over white background) in other examples depending on the theme selection. To determine a timeframe when the icons may be converted to glyphs, the dynamic recoloring module may implement a threshold for visibility or contrast. If one or more icons are not above the threshold, the icons may be converted to glyphs. In the glyph conversion mode, the module may first look for white or similar pixels and make them transparent, and then recolor the rest of the icon to be white.

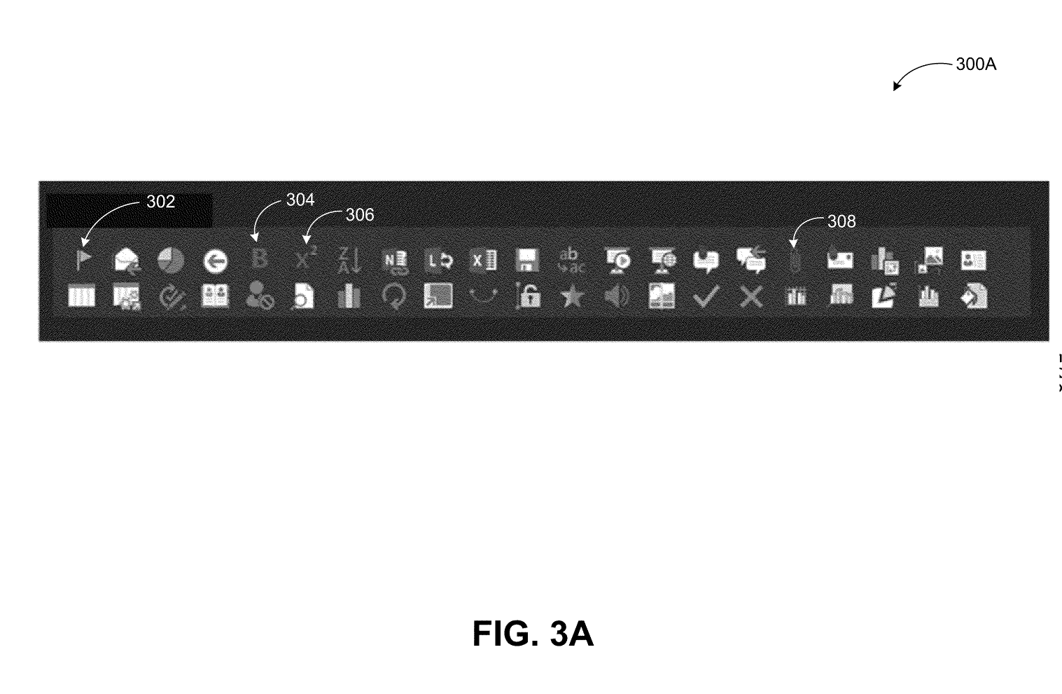

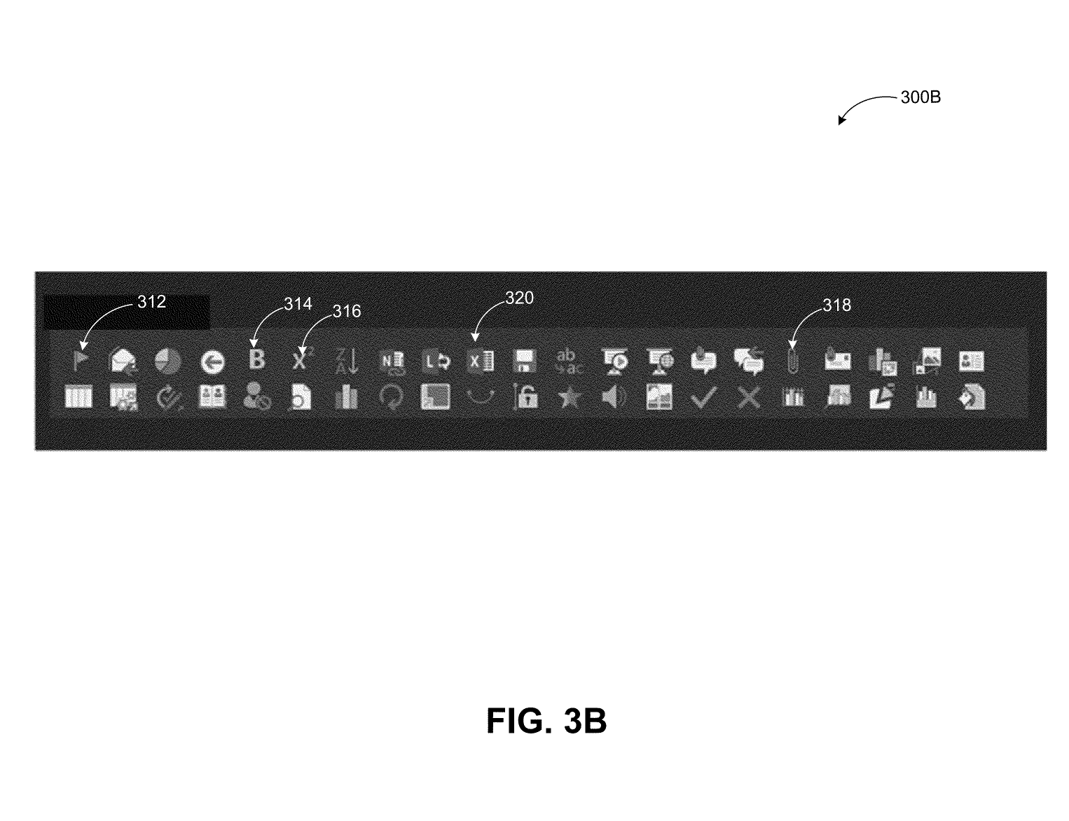

FIGS. 3A and 3B illustrate another example of contrast enhancement of icons on a darker background before and after recoloring, according to at least some examples disclosed herein.

As mentioned previously, a theme change on an application user interface may change the background(s) of icons or other graphic elements darker or lighter. The example icons 300A in FIG. 3 are shown with a much darker background than the example background in FIG. 2. The darker background may render icons, such as 302, 304, 306, and 308 barely visible. Dynamic recoloring may make some icons darker and others lighter to increase contrast levels. In the example recoloring of FIG. 3B, example icons 312, 314, 316, and 318 are made lighter through adjustment of their hue, saturation, luminance parameters (as opposed to the darker change in FIG. 2B). Example icon 320 is not changed because its colors are brand colors. The dynamic recoloring module may also look for colors around a brand color to avoid jagged edges caused by anti-aliasing.

In the illustrative example icons of FIG. 2A through FIG. 3B, the color components of the icons have been removed by converting them to various shades of gray for compliance with rules of various patent agencies. It should be noted that color contrast and visibility may demonstrate itself differently in some situations compared to the gray-shaded illustrations of FIG. 2A through FIG. 3B.

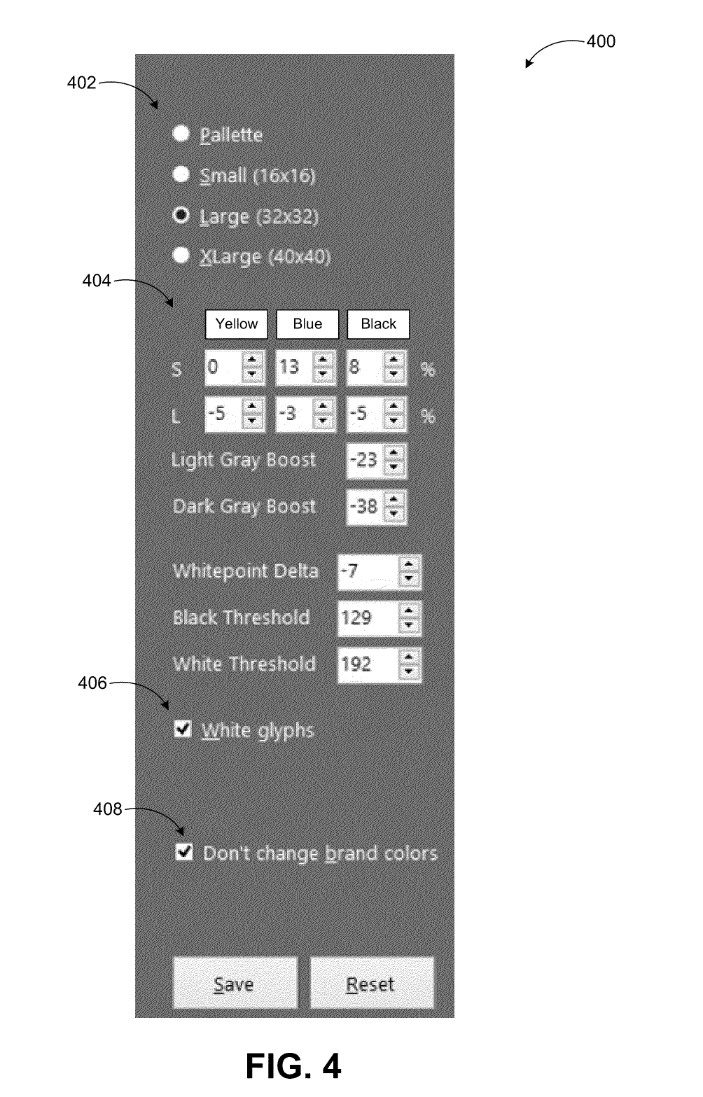

FIG. 4 illustrates an example user interface for manually adjusting color attributes of icons to enhance contrast, according to at least some examples disclosed herein.

A dynamic recoloring module according to some examples may automatically adjust colors of icons (or other graphical elements). In other examples, users or administrators may be enabled to make some or all of the adjustments manually. User interface 400 is an example user interface that may be exposed for that purpose. A user may be able select a bitmap size (402), set various parameters such as saturation, luminance, gray boost levels, etc. (404). The user may also be provided with an option to select glyph conversion (406) and/or to preserve brand colors (408). The user interface 400 is an example user interface. Recoloring of icons may be accomplished through other user interfaces implementing options for different parameters, textual entry, or graphical entries.

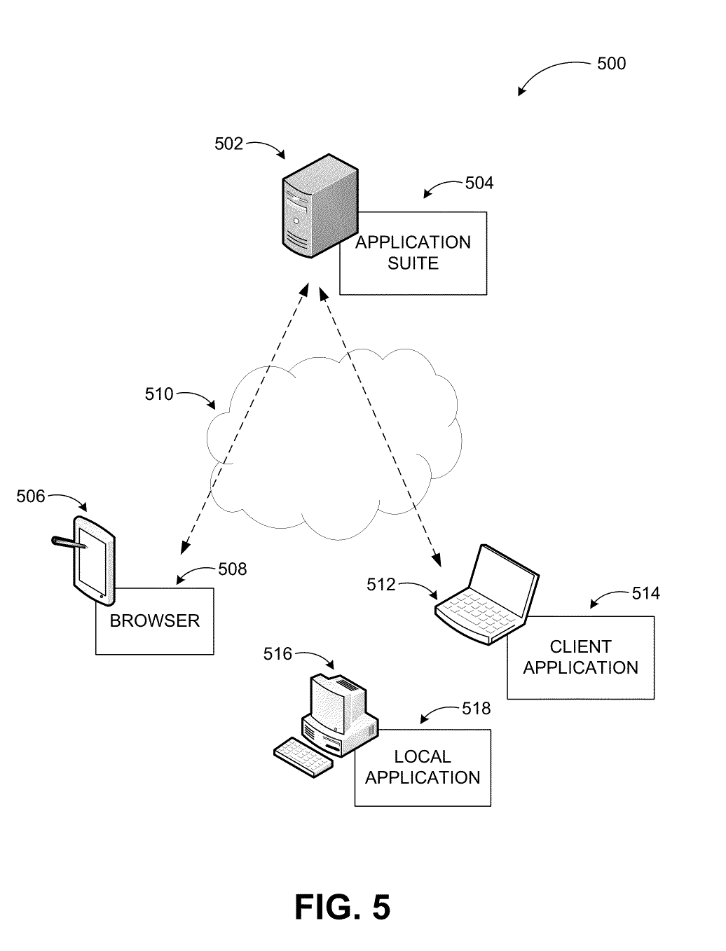

FIG. 5 illustrates an example system, where dynamic recoloring to enhance contrast may be implemented, according to at least some examples disclosed herein.

Dynamic icon recoloring to enhance contrast may be implemented at different levels. As illustrated in diagram 500, one implementation may be automatic recoloring in response to theme changes at application level for an application 518 installed and executed on a computing device 516. Another implementation may be on a client application 514 executed on a computing device 512, where the client application 514 provides services associated with an application suite 504 executed on one or more servers 502 and accessed over one or more networks 510. The recoloring may be controlled at the client application 514 or at the application suite 504. In yet other examples, Dynamic recoloring may be performed at a browser 508 executed on a computing device 506 that provides access to the services provided by the application suite 504 over the network(s) 510. In yet other examples, the dynamic recoloring module may be part of an operating system of a computer and affect one or more applications executed under the operating system. Thus, actual recoloring of icons, graphics, and/or images may be executed on the target device (PC, phone, watch, etc.) as well as on a server (cloud) from which the recolored icons, graphics, and/or images may be pushed to the client devices. The latter may be more appropriate for browsers and underpowered devices, where computing power and memory savings may be desirable.

Inputs for an example dynamic recoloring module may be a selected theme and a section of the user interface that is affected. The module may then determine which icons or graphic elements to adjust and perform the recoloring as described herein. In some case, different user interface sections may be impacted differently under the same theme. Thus, icons for different sections may be recolored accordingly. The changes to the colors of icons may be saved in documents associated with the application or at the application level (local or distributed). In some examples, the changes may be saved in association with a user (e.g., based on user credentials) such that the same changed colors may be used whenever a particular user uses a particular application user interface. Furthermore, the changes may be saved such that they can be applied across multiple devices associated with a user.

According to some examples, the dynamic recoloring of icons may be device/display agnostic. In other examples, device or display attributes may be taken into account when recoloring the icons or graphical elements.

The examples in FIG. 1 through FIG. 5 have been described using specific environments, systems, services, applications, and processes to provide dynamic recoloring of icons to enhance contrast. Examples are not limited to the specific environments, systems, services, applications, and processes according to these examples.

Dynamic recoloring of icons or other graphical elements on a user interface may improve user efficiency. For example, improved graphical display may improve reader efficiency by avoiding difficulty in identifying icons, avoiding confusion between active icons and inactive icons (which are typically shown as lighter version of active icons). The enhanced graphical user interface may decrease mental and physical effort by users to identify icons even with extremely dark backgrounds. Furthermore, increased contrast of icons over darker backgrounds may enable increase user interaction performance, while darker backgrounds may enable more energy efficient displays. Dynamic recoloring may also reduce error rates through reduction of data entry errors. Moreover, by dynamically recoloring individual icons, downloading of entire icon sets for different themes may be avoided, thus reducing memory usage.

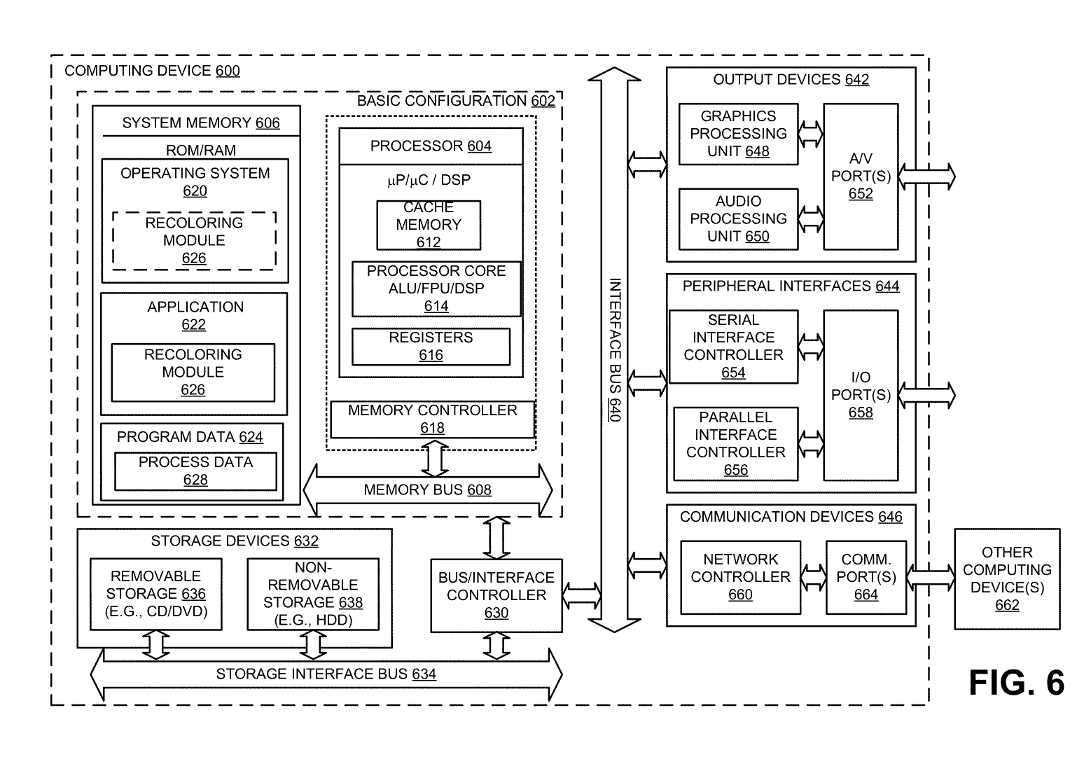

FIG. 6 and the associated discussion are intended to provide a brief, general description of a general purpose computing device, which may be used to provide dynamic recoloring of icons to enhance contrast, according to at least some examples disclosed herein.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communicating between the processor 604 and the system memory 606. The example basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one more levels of caching, such as a level cache memory 612, example processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations the example memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, an application 622, and program data 624. The application 622 may include a dynamic recoloring module 626, which may be an integrated module of the application 622 or an independent module. In some examples the dynamic recoloring module 626 may also be part of the operating system 620. The dynamic recoloring module 626 may perform tasks associated with detection of icon contrast levels, determination of proper adjustments, and adjustment of icon pixels as described herein. The program data 624 may include, among other data, process data 628 related to color parameters of the icons, as described herein.

The computing device 600 may have additional features or functionality, and additional interfaces to facilitate communications between the example basic configuration 602 and any desired devices and interfaces. For example, a bus/interface controller 630 may be used to facilitate communications between the example basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (one or more output devices 642, one or more peripheral interfaces 644, and one or more communication devices 646) to the example basic configuration 602 via the bus/interface controller 630. The one or more output devices 642 may include a graphics processing unit 648 and an audio processing unit 650, which may be configured to communicate to various external devices such as a display or speakers via one or more A/V ports 652. The one or more peripheral interfaces 644 may include a serial interface controller 654 or a parallel interface controller 656, which may be configured to communicate with external devices such as input devices (for example, keyboard, mouse, pen, voice input device, touch input device, etc.) or other peripheral devices (for example, printer, scanner, etc.) via one or more I/O ports 658. The one or more communication devices 646 may include a network controller 660, which may be arranged to facilitate communications with one or more other computing devices 662 over a network communication link via one or more communication ports 664. The one or more other computing devices 662 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

Examples may also include methods to provide dynamic recoloring of icons in order to enhance contrast. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other examples, the human interaction can be automated such as by pre-selected criteria that may be machine automated.

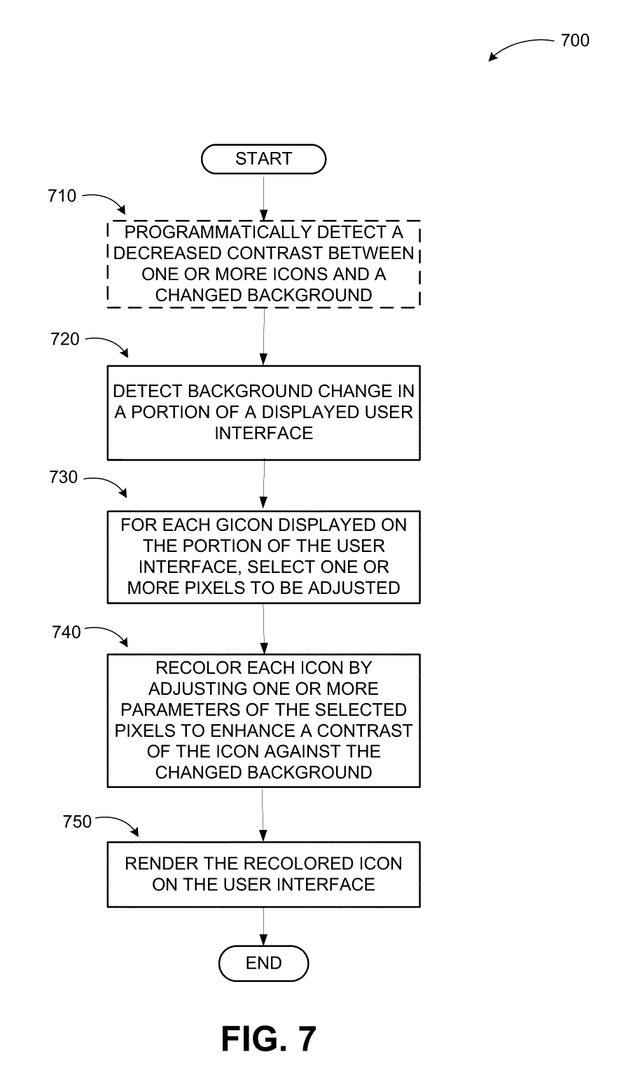

FIG. 7 illustrates a logic flow diagram for process 700 of a method to provide dynamic recoloring of icons to enhance contrast, according to at least some examples disclosed herein. Process 700 may be implemented on a server or other computing devices.

Process 700 begins with optional operation 710, where a contrast decrease between an icon and a background of the user interface displaying the icon is programmatically detected. In other examples, the optional programmatic detection operation may be skipped and dynamic recoloring may begin by default upon detection of the background change.

At operation 720, the background change may be detected in at least one portion of the user interface that may affect visibility of one or more icons (through decrease of contrast, for example).

At operation 730, one or more pixels of each icon may be selected for adjusting. The pixel selection may include criteria such as non-transparent pixels, pixels with colors that degrade more over darker backgrounds compared to other colors, and comparable ones.

At operation 740, each icon may be recolored by adjusting one or more parameters of the selected one or more pixels to enhance a contrast of the icon against the changed background. The parameters may be HSL parameters according to some examples.

At operation 750, the recolored icon may be rendered over the changed background with an increased contrast, and thereby visibility.

The operations included in process 700 are for illustration purposes. Dynamic recoloring of icons to enhance contrast may be implemented by similar processes with fewer or additional steps, as well as in different order of operations using the principles described herein.

According to some examples, methods for dynamic recoloring of a graphical element may be described. An example method may include, detecting a background change in a portion of a displayed user interface; for the graphical element displayed on the portion of the displayed user interface, selecting one or more pixels to be adjusted; recoloring the graphical element by adjusting one or more parameters of the one or more pixels to enhance a contrast of the graphical element against the background change; and enabling rendering of the recolored graphical element on the displayed user interface, wherein the one or more parameters are adjusted at a graphical element level.

According to other examples, the example method may further include detecting a decreased contrast between one or more graphical elements and the background change programmatically. Selecting the one or more pixels to be adjusted may include, according to further examples, designating the one or more pixels having the same color as the background change as not to be adjusted and selecting one or more predefined colors to be adjusted more compared to other colors depending on the background change color.

Recoloring the graphical element may further include converting the graphical element from a red-blue-green (RGB) system to a hue-saturation-luminance (HSL) system and adjusting the one or more parameters of the HSL system of the selected one or more pixels.

Additionally, recoloring the graphical element may further include, according to other examples, adjusting one or more values of a saturation, a luminance, a light gray boost, a dark gray boost, a whitepoint delta, a black threshold, and a white threshold parameters for each of the selected one or more pixels.

According to some examples, recoloring the graphical element may include exempting the one or more pixels that include brand colors from being adjusted. Recoloring the graphical element may further include determining whether a contrast of one or more recolored graphical elements against the background change is below a predefined threshold and in response to a determination that the contrast of the one or more recolored graphical elements against the background change is below the predefined threshold, converting the one or more graphical elements to dual color glyphs. The dual color glyphs may include one or more of: a white over black background and a black over white background.

According to other examples, the example method may further include exposing a recoloring user interface to enable a user to adjust the one or more parameters manually. The graphical element may additionally include one of an icon, a graphic, and an image. The graphic and the image, according to additional examples, may be one of a part of a user interface and a part of a content displayed on the user interface.

According to other examples, computing devices for dynamic recoloring of an icon may be described. An example computing device may include a display device, a memory configured to store instructions, and a processor coupled to the display device and the memory. The processor may be configured to, at least, detect a background change in a portion of a displayed user interface; for the icon displayed on the portion of the displayed user interface, select one or more pixels to be adjusted; recolor the icon; and enable rendering of the recolored icon on the portion of the displayed user interface, wherein the one or more parameters of the HSL system are adjusted at an icon level. Recoloring the icon may involve converting the icon from a red-blue-green (RGB) system to a hue-saturation-luminance (HSL) system and adjusting one or more parameters of the HSL system for the selected one or more pixels to enhance a contrast of the icon against the changed background of the portion of the displayed user interface.

The processor may be further configured to designate the one or more pixels that are the same color as the changed background as not to be adjusted, select one or more predefined colors as to be adjusted more compared to other colors depending on the changed background color, and exempt the one or more pixels that include brand colors from being adjusted. According to further examples, the background change may be due to a theme change in the displayed user interface. The processor may also be further configured to save information associated with the recolored icon in a displayed document on the displayed user interface.

According to further examples, the processor may be further configured to persist the recoloring of the icon at one of an application level, a hosted application suite level, and an operating system level. The processor may also be configured to save information associated with the recolored icon at a user level such that the recolored icon are persisted on one or more devices associated with a user.

According to some examples, a computer-readable memory device to store instructions for dynamic recoloring of an icon may be described. The instructions, when executed by a computing device, may cause actions to be performed. The actions may include, at least, detecting a background change in a first portion of a displayed user interface; programmatically detecting a decreased contrast between one or more icons and the changed background; for the icon with a decreased contrast, selecting one or more pixels to be adjusted; recoloring the icon; and enabling rendering of the recolored icon on the portion of the displayed user interface, wherein the one or more parameters of the HSL system are adjusted at an icon level. Recoloring the icon may involve converting the icon from a red-blue-green (RGB) system to a hue-saturation-luminance (HSL) system and adjusting one or more parameters of the HSL system for the selected one or more pixels to enhance a contrast of the icon against the changed background of the portion of the displayed user interface.

According to further examples, the computer-readable memory device may also include a dynamic recoloring module. The dynamic recoloring module may be configured to perform the actions at one of: an application level, an operating system level, and a hosted application suite level. The actions, when the dynamic recoloring module is at the hosted application suite level, may include enabling exemption of one or more applications associated with the hosted application suite to be exempted from the recoloring.

The above specification, examples and data provide a complete description of the manufacture and use of the composition of the examples. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and examples.

What is claimed is:

1. A method for dynamic recoloring of a graphical element, the method comprising:
detecting a background change in a portion of a displayed user interface;
for the graphical element displayed on the portion of the displayed user interface, selecting one or more pixels to be adjusted;
recoloring the graphical element by adjusting one or more parameters of the selected one or more pixels to enhance a contrast of the graphical element against the background change; and
enabling rendering of the recolored graphical element on the displayed user interface, wherein the one or more parameters are adjusted at a graphical element level.

2. The method of claim 1, further comprising:
detecting a decreased contrast between one or more graphical elements and the background change programmatically.

3. The method of claim 1, wherein selecting the one or more pixels to be adjusted comprises:
designating one or more other pixels having the same color as the background change as not to be adjusted; and
selecting one or more predefined colors to be adjusted more compared to other colors depending on the background change color.

4. The method of claim 1, wherein recoloring the graphical element further comprises:
converting the graphical element from a red-blue-green (RGB) system to a hue-saturation-luminance (HSL) system; and
adjusting the one or more parameters of the HSL system of the selected one or more pixels.

5. The method of claim 4, wherein recoloring the graphical element further comprises:
adjusting one or more values of a saturation, a luminance, a light gray boost, a dark gray boost, a whitepoint delta, a black threshold, and a white threshold parameters for each of the selected one or more pixels.

6. The method of claim 1, wherein recoloring the graphical element further comprises:
exempting pixels that include brand colors from being adjusted.

7. The method of claim 1, wherein recoloring the graphical element further comprises:
determining whether a contrast of one or more recolored graphical elements against the background change is below a predefined threshold; and
in response to a determination that the contrast of the one or more recolored graphical elements against the background change is below the predefined threshold, converting all graphical elements to dual color glyphs.

8. The method of claim 7, wherein the dual color glyphs include one or more of: a white over black background and a black over white background.

9. The method of claim 1, further comprising:
exposing a recoloring user interface to enable a user to adjust the one or more parameters manually.

10. The method of claim 1, wherein the graphical element includes one of an icon, a graphic, and an image.

11. The method of claim 10, wherein the graphic and the image are one of a part of a user interface and a part of a content displayed on the user interface.

12. A computing device for dynamic recoloring of an icon, the computing device comprising:
a display device;
a memory configured to store instructions; and
a processor coupled to the display device and the memory, wherein the processor is configured to:
detect a background change in a portion of a displayed user interface;
for the icon displayed on the portion of the displayed user interface, select one or more pixels to be adjusted;
recolor the icon by:
converting the icon from a red-blue-green (RGB) system to a hue-saturation-luminance (HSL) system; and
adjusting one or more parameters of the HSL system for the selected one or more pixels to enhance a contrast of the icon against the changed background of the portion of the displayed user interface; and
enable rendering of the recolored icon on the portion of the displayed user interface, wherein the one or more parameters of the HSL system are adjusted at an icon level.

13. The computing device of claim 12, wherein the processor is further configured to:
designate one or more other pixels that are the same color as the changed background as not to be adjusted;
select one or more predefined colors as to be adjusted more compared to other colors depending on the changed background color; and
exempt pixels that include brand colors from being adjusted.

14. The computing device of claim 12, wherein the background change is due to a theme change in the displayed user interface.

15. The computing device of claim 12, wherein the processor is further configured to:
save information associated with the recolored icon in a displayed document on the displayed user interface.

16. The computing device of claim 12, wherein the processor is further configured to:
persist the recoloring of the icon at one of an application level, a hosted application suite level, and an operating system level.

17. The computing device of claim 12, wherein the processor is further configured to:
save information associated with the recolored icon at a user level such that the recolored icon is persisted on one or more devices associated with a user.

18. A computer-readable memory device to store instructions for dynamic recoloring of an icon, wherein the instructions, when executed by a computing device, cause actions to be performed, the actions comprising:
detecting a background change in a first portion of a displayed user interface;
programmatically detecting a decreased contrast between one or more icons and the changed background;
for each of the one or more icons with a decreased contrast, selecting one or more pixels to be adjusted;
recoloring the one or more icons by:
converting the one or more icons from a red-blue-green (RGB) system to a hue-saturation-luminance (HSL) system; and
adjusting one or more parameters of the HSL system for the selected one or more pixels to enhance a contrast of the one or more icons against the changed background of the portion of the displayed user interface; and
enabling rendering of the recolored one or more icons on the portion of the displayed user interface, wherein the one or more parameters of the HSL system are adjusted at an icon level.

19. The computer-readable memory device of claim 18, wherein a dynamic recoloring module is configured to:
perform the actions at one of: an application level, an operating system level, and a hosted application suite level.

20. The computer-readable memory device of claim 19, wherein the actions, when the dynamic recoloring module is at the hosted application suite level, further comprise:
enabling exemption of one or more applications associated with the hosted application suite to be exempted from the recoloring.
